(19) United States
(12) Patent Application Publication
(10) Pub. No.: US 2015/0022844 A1
(43) Pub. Date: Jan. 22, 2015

(54) USER CREDENTIALS FOR PERFORMING MULTIFUNCTION DEVICE WORKFLOW ACTION

(71) Applicant: Hewlett-Packard Development Company, L.P., Houston, TX (US)

(72) Inventors: Helen Y. Balinsky, Bristol (GB); Jon T. Huber, Boise, ID (US); Cesare Gritti, Boulder, CO (US)

(21) Appl. No.: 13/942,996

(22) Filed: Jul. 16, 2013

(51) Int. Cl. H04N 1/00

(52) U.S. Cl. CPC H04N 1/00854
USPC 358/1.14

(57) ABSTRACT

A user profile includes user credentials that are accessible from a multifunction device. A user credential is selected from the user profile using the multifunction device. The selected user credential is used to perform a workflow action at the multifunction device.

### BACKGROUND

A multifunction device is an office machine which incorporates the functionality of multiple devices to provide centralized document distribution and production. A multifunction device may perform any combination of the following functions: sending email, faxing, photocopying, printing and scanning. A multifunction device may also provide temporary document storage with security, authentication using common network credentials, network scan destinations, and encryption for data transmission. Multifunction devices may also be referred to as all-in-one devices or multifunction printers.

### BRIEF DESCRIPTION OF THE DRAWINGS

The following detailed description references the drawings, wherein:

FIG. 1 is a block diagram of an example multifunction device in communication via a network with a client computing device for performing a workflow action on a document at a multifunction device;

FIG. 2 is an example of a user profile including user credentials for access by a multifunction device;

FIG. 3 is a flowchart of an example method for execution by a multifunction device for performing a workflow action on a document;

FIG. 4 is a flowchart of an example method for execution by a multifunction device for encrypting a document using an encryption key;

FIG. 5 is a flowchart of an example method for execution by a multifunction device for decrypting a document using an decryption key;

FIG. 6 is a flowchart of an example method for execution by a multifunction device for generating a signature for a document using a signature generation key;

FIG. 7 is a flowchart of an example method for execution by a multifunction device for verifying a document signature using a signature verification key; and

FIG. 8 is a flowchart of an example method for execution by a multifunction device 60 for managing a user profile.

### DETAILED DESCRIPTION

Many digital document workflows necessitate workflow participants to own and use their credentials to complete assigned workflow tasks. Workflows that carry private or confidential data may require formal authorization or approval to execute the workflow. For example, a multifunction device may require a user to provide an encryption key before a document may be encrypted. Similarly, a multifunction device may need to access a user's decryption key before a document accessed at the multifunction printer may be decrypted. Thus, the ability to access and manage user credentials is a growing necessity for multifunction devices.

Examples disclosed herein address these issues by providing a user profile that includes user credentials that may be accessed from a multifunction device. The user profile may be stored locally at the multifunction device or may be stored in a storage device connected to the multifunction device. The user profile may also be stored at a remote location such that the multifunction device may access the user profile over a network.

The user credentials included in the user profile may include information to be used to perform workflow actions at the multifunction device. Example user credentials may include secret cryptographic keys, decryption keys, encryption keys, signature generation keys, signature verification keys, public key certificates, and public keys associated with other users.

The multifunction device may receive a user input to perform a workflow action on a document. In response to the user input, the user profile may be accessed and a user credential associated with the workflow action may be selected. The multifunction device may then cause the workflow action to be performed on the document using the user credential. For example, a user may desire to encrypt a document at multifunction device. The user's profile is accessed to select an encryption key from the user's credentials. The document may then be encrypted at the multifunction device using the encryption key.

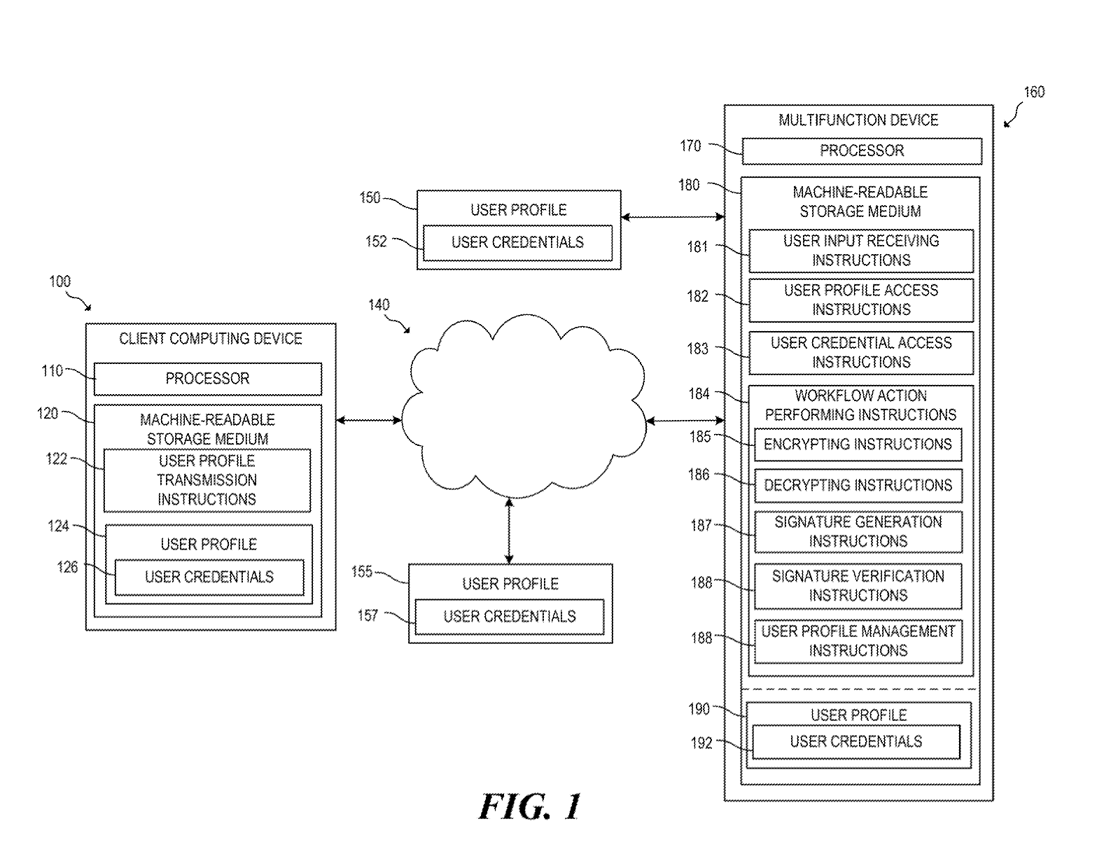

Referring now to the drawings, FIG. 1 is a block diagram of a multifunction device 160 in communication via a network 140 with a client computing device 100. As illustrated in FIG, 1 and described below, multifunction device 160 may access a user profile to perform a workflow action on a document at multifunction device 160.

Multifunction device 160 may be any device that provides multiple functions that may be performed on a document and is accessible to a client device such as client computing device 100. In the embodiment of FIG. 1, multifunction device 160 includes a processor 170 and a machine-readable storage medium 180.

Processor 170 may be one or more central processing units (CPUs), microprocessors, and/or other hardware devices suitable for retrieval and execution of instructions stored in machine-readable storage medium 180. Processor 170 may fetch, decode, and execute instructions 181, 182, 183, 184, 185, 186, 187, 188, 189 to perform a workflow action at a multifunction printer, as described below. As an alternative or in addition to retrieving and executing instructions 181-189, processor 170 may include one or more electronic circuits comprising a number of electronic components for performing the functionality of one or more of instructions 181-189.

Machine-readable storage medium 180 may be any electronic, magnetic, optical, or other physical storage device that stores executable instructions. Thus, machine-readable storage medium 180 may be, for example, Random Access Memory (RAM), an Electrically-Erasable Programmable Read-Only Memory (EEPROM), a storage drive, an optical disc, and the like. As described in detail below, machine-readable storage medium 180 may be encoded with executable instructions 181-188 for performing a workflow action on a document. User profile 190 including user credentials 192 may also be stored on machine-readable storage medium 180.

In some implementations, user profile 150 including user credentials 152 may be directly accessed by multifunction device 160. For example, user profile 150 may be stored on and accessed from an external storage device, such as a universal serial bus (USB) flash memory storage device that is inserted into a USB port of multifunction device 160. In other implementations, user profile 155 including user credentials 157 may be accessed at an external location via network 157. For example, user profile 155 may be accessed from any storage accessible to multifunction device 160 via network 140.

Client computing device 100 may be, for example, a notebook computer, a desktop computer, an all-in-one system, a thin client, a workstation, a tablet computing device, a mobile phone, or any other computing device suitable for execution of the functionality described below. In FIG. 1, client computing device 100 includes processor 110 and machine-readable storage medium 120.

As with processor 170 of multifunction device 160, processor 110 may be one or more CPUs, microprocessors, and/or other hardware devices suitable for retrieval and execution of instructions 122. Processor 110 may fetch, decode, and execute instructions 122. Processor 110 may also or instead include electronic circuitry for performing the functionality of instructions 122. As with storage medium 180 of multifunction device 160, machine-readable storage medium 120 may be any physical storage device that stores executable instructions. User profile 124 including user credentials 126 may be stored on machine-readable storage medium 120 for retrieval by multifunction device 160.

Communication may be established between client computing device 100 and multifunction device 160. For example, client computing device 100 may access multifunction device 160 at a predetermined Internet Protocol (IP) address and, in response, multifunction device 160 may establish a communication session with client computing device 100. In some implementations, client login credentials, such as a user identifier and a corresponding authentication parameter e.g., a password) may be used to establish communication with multifunction device 160.

User input receiving instructions 181 may receive a user input from a workflow participant at multifunction device 160 to perform a workflow action on a document. Example workflow action may include: encrypting a document that was just scanned, decrypting an encrypted document that was sent to be printed, digitally signing or certifying a recently scanned document, and verifying a signature of a received document prior to printing its contents.

User profile access instructions 182 may access a user profile associated with the workflow participant. The user profile can be stored locally or remotely, but accessed at multifunction device 160 when a user is operating a control panel of the multifunction device 190. Accordingly, the user may be provided with any cryptographic objects for enabling performance of workflow actions.

In one implementation, the user profile may be stored locally within multifunction device 160, such as user profile 190. In another implementation, the user profile may be stored in an external storage accessible from multifunction device 160, such as user profile 150. In a further implementation, the user profile may be accessed from storage on client computing device 100, such as user profile 124. In yet another implementation, the user profile may be stored at a remote network location, such as user profile 155, and accessed via network 140. Example remote network locations may include, a corporate lightweight directory access protocol (LDAP) repository, a database, a cloud service, and other identity service providers.

Each user profile includes user credentials 126, 152, 157, 192 that may be used to complete workflow actions. Example user credentials 126, 152, 157, 192 may include an encryption key, a decryption key, a signature generation key, a signature verification key, public key certificates, and keys associated with other users.

User credential access instructions 183 may select and access a particular user credential associated with a workflow action. For example, if the workflow action is encrypting a document, an encryption key is accessed from the user profile. In another example, if the workflow action is decrypting a document, a decryption key is accessed from the user profile. In some implementations, a user confirms selection of the appropriate user credential for performing the workflow action.

Workflow action performing instructions 184 may use the user credential to execute any of instructions 185, 186, 187, 188, 189 to perform the requested workflow action, as discussed below.

In one implementation, the workflow action is encrypting a document. User credential selection instructions 183 may select and access an encryption key from user credentials of a user profile. For example, the encryption key may be accessed from user credentials 126 of user profile 124 stored at client computing device 100. User profile transmission instructions 122 may cause the user profile to be transmitted to multifunction device 160 over network. In some implementations, rather than transmitting user profile to multifunction device 160, only the encryption key from user credentials 126 is transmitted from client computing device 100 to multifunction device 160 over network 140. Encrypting instructions 185 may cause a document to be encrypted using the encryption key before the document is transmitted from multifunction device 160 to a recipient.

In another implementation, the workflow action is decrypting a document. User credential selection instructions 183 may select and access a decryption key from user credentials of a user profile. For example, the decryption key may be accessed from user credentials 152 of user profile 150 stored in an external storage device connected to multifunction device 160, The storage device may be a flash storage device connected to a USB port of multifunction device 160. Decrypting instructions 186 may decrypt a document at multifunction device 160 using the decryption key accessed from user credentials 152.

In a further implementation, the workflow action is generating a signature for a document. User credential selection instructions 183 may select and access a signature generation key from user credentials of a user profile. For example, the signature generation key may be accessed from user credentials 192 of user profile 190 stored at multifunction device 160. Signature generation instructions 187 may cause a signature to be generated at multifunction device 160 using the signature generation key. Multifunction device 160 may then cause the document and the generated signature to be transmitted from multifunction device 160 to a recipient.

In yet a further implementation, the workflow action is verifying a signature of a received document. User credential selection instructions 183 may select and access a signature verification key from user credentials of a user profile. For example, the signature verification key may be accessed from user credentials 157 of user profile 155 stored at a remote network location. Signature verification instructions 188 may cause the signature verification key accessed from user credentials 157 to verify a signature of the document received at multifunction device 160 to authenticate the received document.

In still a further implementation, the workflow action is managing a user profile. User profile management instructions 189 may be used to access and manage a user profile, such as user profile 124, user profile 150, user profile 155, or user profile 190. A system administrator of multifunction device 160 may have authorized specific users who are authorized to access, create, and manage user profiles at the multifunction device. In some implementations, each user may be authorized to manage their own user profile at multifunction device 160. In other implementations, a select number of users may be authorized to manage the user profiles of other users.

User profile management instructions 189 may be used to verify that a user that attempts to access a user profile at multifunction device 160 is authorized to manage the user profile. A user profile may include private user credentials (e.g., a private decryption key) and public user credentials (e.g., the public keys of other users). In some implementations, no verification is required for a user to access another user's public credentials from that users profile.

An authorized user may manage a user profile by inputting a profile management action. Example profile management actions may include generating new keys, updating keys received from other users, discarding expired keys, discarding compromised keys, and creating a new user profile In response to the input from the authorized user, access may be granted to the entire user profile or a portion of the user profile. A portion of the user profile that the user may be granted access to may be the user credential(s) that corresponds to the user profile management action. In some implementations, access to the user profile may require authentication. Examples of authentication may include a PIN, password, passphrase, finger print, smart card, or lightweight directory access protocol (LDAP) authentication.

User profile management instructions 189 may then be used to manage the user profile in accordance with the profile management action. For example, user profile management instructions 189 may cause a user profile to be changed by generating new keys for the user profile, updating keys in the user profile that are received from other users, discarding expired keys from the user profile, and discarding compromised keys from the user profile. In another example, user profile management instructions 189 may cause a new user profile to be created and any user credentials may be added to the new user profile.

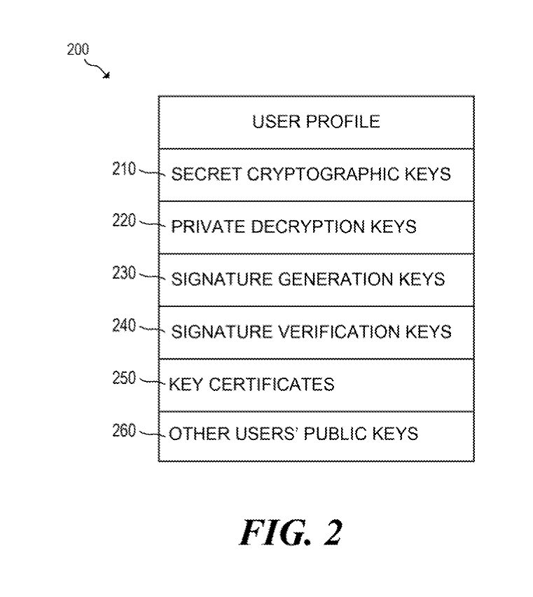

FIG. 2 is an example of a user profile 200 including user credentials for access by a multifunction device. Example user credentials may include secret cryptographic keys 210, private decryption keys 220, signature generation keys 230, signature verification keys 240, key certificates 250, and keys associated with other users 260. Each user credential may be individually accessible or may be password protected.

In a symmetric encryption scheme, the encryption and decryption keys may be the same. A secret cryptographic key 210 may be shared with other users. Accordingly, a document may be encrypted at multifunction device 160 using secret cryptographic key 210, and the encrypted document may be forwarded to a recipient, for example, as an attachment to an email. The recipient may access the encrypted document and cause the document to be decrypted using secret cryptographic key 210. In some implementations, the recipient may be in possession of secret cryptographic key 210. In other implementations, the recipient may access secret cryptographic key 210 from user profile 200 associated with the user that sent the encrypted document. In other words, users not associated with a user profile may still access some user credentials of the user profile. Accordingly, a user profile may include a private profile, which may include credentials that may be made accessible by the user associated with the profile, and a public profile, which may include credentials that may be made accessible by other users. In some implementations, user profile 200 may be partitioned on other parts with fine-grained access to each part of profile.

In an asymmetric encryption scheme, an encryption key may be public, meaning that the encryption key may be published for any user to access and encrypt documents, and the decryption key may be private. In this case, the encryption key may be part of the public profile of the user profile, and the decryption key may be part of the private profile of the user profile. A document may be encrypted using a public encryption key. The public encryption key may be accessed from the sender's user profile or from an intended recipient's user profile. The encrypted document may then be transmitted to the recipient at multifunction device 160, for example, by downloading the encrypted document from a shared drive. Multifunction device 160 may access private decryption key 220 from user profile 200. Private decryption key 220 may then be used to decrypt the document at multifunction device 160. The decrypted document may then be subsequently printed.

A digital signature is a scheme for proving the authenticity of a document. A valid digital signature provides the recipient of the document with authentication that the document was created by and received from a known sender. A valid digital signature also protects the integrity of the document to ensure that the document was not altered during transmission. A signature generation key 230 may be used to generate a signature for a document at multifunction device 160. Signature generation key 230 may be a private key that is used with the document to produce a signature for the document. The signed document may then be transmitted to a recipient from multifunction device 160. A signature verification key 240 may be a public key. When a signed document is received at multifunction device 160, signature verification key 240 may be used to verify the document's claim to authenticity such that the document may be either accepted or rejected.

Actual keys in user profile 200 may be used to enable a corresponding action. However, a key in user profile 200 may be stored in different forms such as row keys serialized in bytes, in a keystore format (e.g. java keystore), or in the form of a certificate, such as key certificate 250. For example, a certificate such as PKCS#12 may be used to keep a pair of user private and public keys.

User profile 200 may include other users' public keys 260. By enabling access to other users' public keys 260 from user profile 200, a user may be able to perform a workflow action on a document, such as encryption, using a credential associated with a different user, e.g., a public encryption key of that different user. For example, a user may want to encrypt a document before sending the encrypted document to a different user. In this example, the multifunction device may access an encryption key associated with the different user from other users' public keys 260 in order to encrypt the document before sending the encrypted document to the different user. A user may manage the user profile 200 at multifunction device 160. For example, a user may add user credentials, update user credentials, delete user credentials, or create a new user profile at multifunction device 160. For example, a user may add, update, or delete user credentials by accessing user profile 200 from any stored location using multifunction device 160. In some implementations, the user may use functionality provided by multifunction device 160 to generate new keys, generate certificates, generate certificate signing requests, and communicate with a certificate authority.

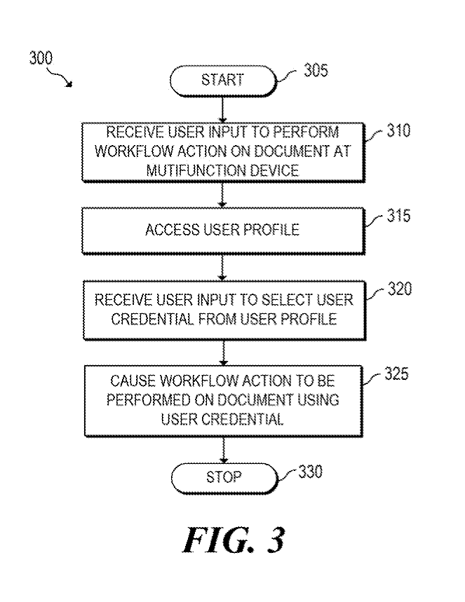

FIG. 3 is a flowchart of an example method 300 for execution by multifunction device 160 for managing user credentials associated with a multifunction device. Although execution of method 300 is described below with reference to multifunction device 160 of FIG. 1, other suitable devices for execution of method 300 will be apparent to those of skill in the art. Method 300 may be implemented in the form of executable instructions stored on a machine-readable storage medium, such as storage medium 180, and/or in the form of electronic circuitry.

Method 300 may start in block 305 and continue to block 310, where a user input is received at multifunction device 160 to perform a workflow action on a document at the multifunction device. Example workflow actions may include: encrypting a just scanned document that may be confidential, private or otherwise have restricted access; decrypting a received document before printing; digitally signing or certifying a just scanned document and subsequently sending it out of multifunction device 160 (e.g. by emailing or uploading the digitally signed file); verifying a signature on a received document; accessing confidential documents at multifunction device to decrypt the document before printing; checking the authenticity of a document before printing; and any combinations of the above (e.g., encrypting and signing a just scanned document). Next, in block 315, a user profile is accessed. The user profile may include user credentials to be used to complete a desired workflow action on the document.

In block 320, a user credential is accessed from the user profile. Example user credentials may include secret cryptographic keys, private decryption and public encryption keys, signature generation and signature verification keys, public key certificates, and public keys associated with other users. Other user credentials that may be accessed from the user profile may be associated with timestamping and transaction identification generation.

Finally, in block 325, multifunction device 160 causes the workflow action to be performed on the document using the user credential. For example, a public key certificate and a signature generation key may be accessed from the user profile. The signature generation key may be used to digitally sign a document. The signature generation key is private and remains secret. For each signature key there is a corresponding unique signature verification key. The signature verification key is publicly known and allows other users to verify the signature generated using the private signature generation key. The public signature verification key is often wrapped into a certificate such that a user's known identity is bound with the user's public key. The certificate may then be sent along with the document to a recipient. Method 300 then proceeds to block 330 where method 300 stops.

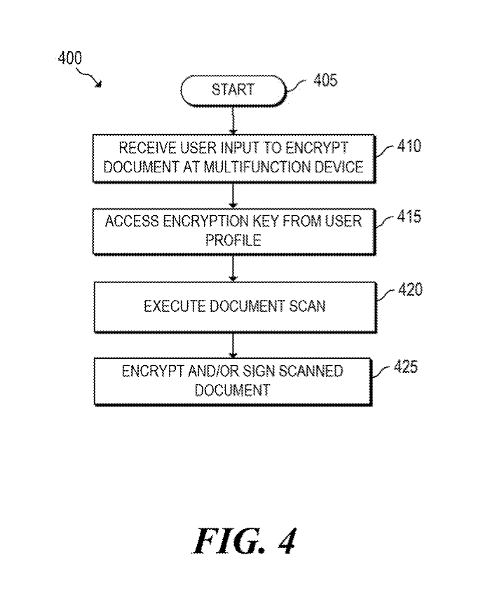

FIG. 4 is a flowchart of an example method 400 for execution by multifunction device 160 for encrypting a document at the multifunction device. Although execution of method 400 is described below with reference to multifunction device 160 of FIG. 1, other suitable devices for execution of method 400 will be apparent to those of skill in the art. Method 400 may be implemented in the form of executable instructions stored on a machine-readable storage medium, such as storage medium 180, and/or in the form of electronic circuitry.

Method 400 may start in block 405 and continue to block 410, where a user input is received at multifunction device 160 to encrypt a document at the multifunction device. The document may be stored at multifunction device 160 or scanned using scanning functionality of multifunction device 160. In the case where multifunction device 160 serves as a document center, a document may be submitted to multifunction device 160 through a print job channel with the intention to encrypt and/or print the document. For example, a document may be sent to multifunction device 160 over a secure network within an organization. The document may be encrypted and/or signed, and then sent outside of the organization.

Next, in block 415, an encryption key is accessed from user credentials of a user profile. The encryption key may be a secret cryptographic key that is shared with the intended recipient of the document to be encrypted.

Next, in block 420, in the case where the document is to be scanned at multifunction device 160, multifunction device 160 executes a scanning operation to scan data that is provided on the document. In the case where the document data is available at multifunction device 160, the scanning operation need not be performed.

Finally, in block 425, multifunction device 160 causes the scanned document data to be encrypted and/or signed soon after the document is scanned. The scanned document data may be encrypted using the encryption key. The scanned document data may be signed using a signature key. In some implementations, the document data may then be transmitted to a recipient, for example, as an email attachment. In other implementations, the document data may be uploaded to a remote location For example, the document data may be saved to storage in a local USB-connected device. In the case of symmetric cryptography, the recipient may decrypt the document data using the encryption key. In some implementations, the recipient may access the encryption key from the user profile of the user that sent the document. In other implementations, the recipient may access the encryption key from the recipient's own user profile.

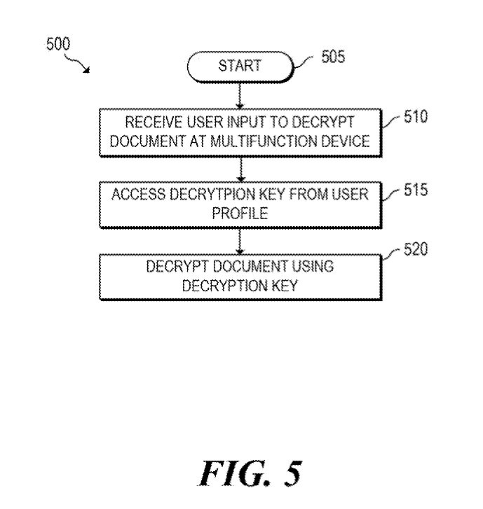

FIG. 5 is a flowchart of an example method 500 for execution by multifunction device 160 for decrypting a document at the multifunction device. Although execution of method 500 is described below with reference to multifunction device 160 of FIG. 1, other suitable devices for execution of method 500 will be apparent to those of skill in the art. Method 500 may be implemented in the form of executable instructions stored on a machine-readable storage medium, such as storage medium 180, and/or in the form of electronic circuitry.

Method 500 may start in block 505 and continue to block 510, where a user input is received at multifunction device 160 to decrypt a document at multifunction device 160. In some implementations, the document may have been sent to multifunction device 160 by, for example, being submitted as a print job that may be stored locally at multifunction device 190. In other implementations, a user may have to interact with a control panel of multifunction device to cause a document to be downloaded to multifunction device 160 from either local or remote storage. Next, in block 515, a decryption key is accessed from user credentials of a user profile. In some implementations, the decryption key may be accessed from the user profile stored at multifunction device 160. In other implementations, the decryption key may be accessed from the senders user profile, for example, at a remote network location.

Finally, in block 520, multifunction device 160 causes the document o be decrypted using the decryption key. Method 500 may then cause the decrypted document to be printed.

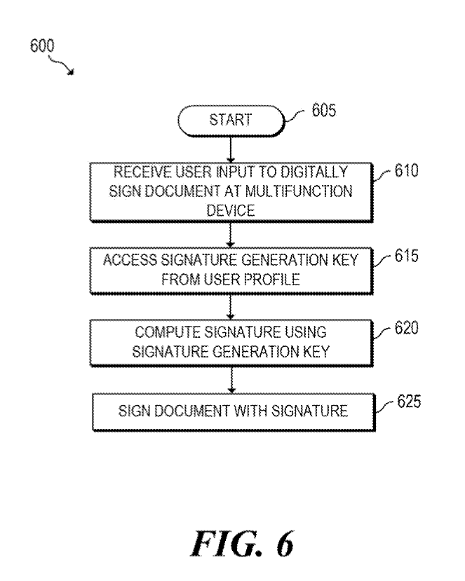

FIG. 6 is a flowchart of an example method 600 for execution by multifunction device 160 for digitally signing a document at the multifunction device. Although execution of method 600 is described below with reference to multifunction device 160 of FIG. 1, other suitable devices for execution of method 600 will be apparent to those of skill in the art. Method 600 may be implemented in the form of executable instructions stored on a machine-readable storage medium, such as storage medium 180, and/or in the form of electronic circuitry.

Method 600 may start in block 605 and continue to block 610, where a user input is received at multifunction device 160 to digitally sign a document at the multifunction device. For scanned documents, digital signatures establish authenticity and safeguard the documents from the point of document creation. A valid digital signature provides the recipient of the document with authentication that the document was created by and received from a known sender. A valid digital signature also protects the integrity of the document to ensure that the document has not been altered during transmission.

Next, in block 615, a signature generation key is accessed from user credentials of a user profile. In some implementations, the signature generation key is a private key. In block 620, a signature is computed for the document using the signature generation key.

Finally, in block 625, multifunction device 160 causes the document to be digitally signed with the signature. The signed document may then be exported from multifunction device. For example, the signed document may be transmitted to a recipient as an attachment to an email.

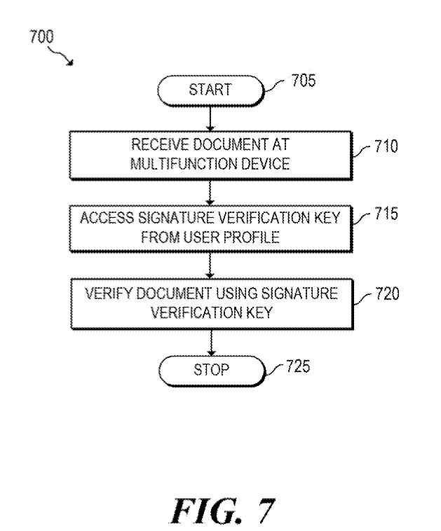

FIG. 7 is a flowchart of an example method 700 for execution by multifunction device 160 for verifying a signature provided with a document received at the multifunction device. Although execution of method 700 is described below with reference to multifunction device 160 of FIG. 1, other suitable devices for execution of method 700 will be apparent to those of skill in the art. Method 700 may be implemented in the form of executable instructions stored on a machine-readable storage medium, such as storage medium 180, and/or in the form of electronic circuitry.

Method 700 may start in block 705 and continue to block 710, where a document is received at multifunction device 160. The document may be received from a sender that a user may want to verify.

Next, in block 715, a signature verification key associated with the sender is accessed from user credentials of a user profile. In some implementations, the signature verification key may be accessed from the user profile in response to user input at multifunction device 160. In other implementations, the signature verification key may be accessed from the user profile in response to receiving the document at multifunction device 160.

Finally, in block 720, multifunction device 160 verifies the signature provided with the document using the signature verification key. If the signature verification key verifies the sender's signature, the document is accepted as authentic; otherwise the document is rejected. Method 700 then proceeds to block 725 where method 700 stops.

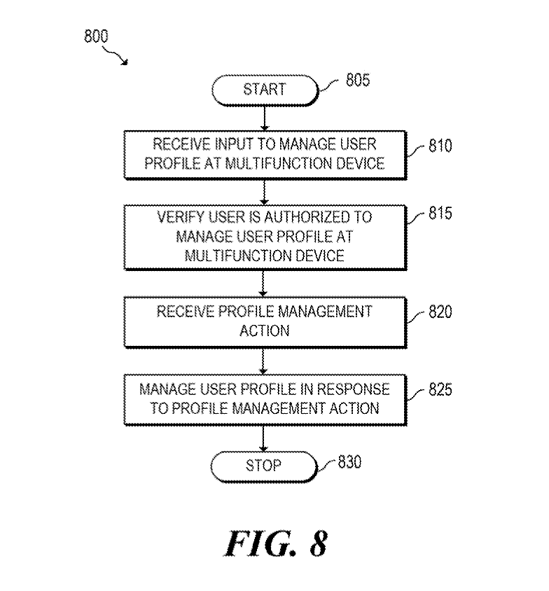

FIG. 8 is a flowchart of an example method 800 for execution by multifunction device 160 for managing a user profile at the multifunction device. Although execution of method 800 is described below with reference to multifunction device 160 of FIG. 1, other suitable devices for execution of method 800 will be apparent to those of skill in the art. Method 800 may be implemented in the form of executable instructions stored on a machine-readable storage medium, such as storage medium 180, and/or in the form of electronic circuitry.

Method 800 may start in block 805 and continue to block 810, where an input is received to manage a user profile at multifunction device 160. A system administrator of multifunction device 160 may have specified which users are authorized to manage user profiles at the multifunction device. An authorization profile may be stored at multifunction device 160 or may be accessed at multifunction device 160 from an external storage location. The authorization profile may identify those users who are trusted to manage the user profiles at multifunction device 160. In some implementations, each user may be authorized to manage their own user profile at multifunction device 160. In other implementations, a select number of users may be authorized to manage the user profiles of other users.

Next, in block 815, the user that desires to manage a user profile at multifunction device 160 is verified to determine whether the user is authorized to manage the desired user profile. A user profile may include private user credentials (e.g., a private decryption key) and public user credentials (e.g., the public keys of other users). In some implementations, no verification is required for a user to manage another user's public credentials from that user's profile. If the user is not authorized to manage the user profile, processing stops. If the user is verified as an authorized user to manage the user profile, processing continues to block 820.

In block 820, input is received at multifunction device 160 from an authorized user to manage a user profile. The input may correspond to a profile management action. Example profile management actions may include generating new keys, updating keys received from other users, discarding expired keys, discarding compromised keys, and creating a new user profile. In response to the input from the authorized user, access may be granted to the entire user profile or a portion of the user profile. For example, a user profile may be stored at multifunction device 160. In this example, an authorized user may be granted access to manage the full user profile such that the authorized user may manage any part of the user profile.

In another example, a user profile may be stored at a remote network location. In this example, only the user credentials that correspond to the profile management action may be provided to multifunction device 160. However, any public user credentials may also be provided to multifunction device 160 even though the authorized user may not have requested that any profile management action be taken on the public user credentials. In some implementations, any private user credentials that are provided to multifunction device 160 from a remote network location may be delivered over an encrypted channel.

Finally, in block 825, the user profile may be managed in response to the authorized user's input. For example, multifunction device 160 may cause a user profile to be changed by generating new keys for the user profile, updating keys in the user profile that are received from other users, discarding expired keys from the user profile, and discarding compromised keys from the user profile. In another example, a new user profile is created and any user credentials may be added to the new user profile. Method 800 then proceeds to block 830 where method 800 stops.

The foregoing disclosure describes a number of examples for performing a workflow action at a multifunction device. In this manner, the examples disclosed herein enable a user to cause workflow actions to be performed at the multifunction device by accessing user credentials from a user profile accessible from the multifunction device.

We claim:

1. A method of performing a workflow action at a multifunction device, the method comprising:
receiving a document for which a workflow action is to be performed at a multifunction device;
accessing a user profile associated with a user for enabling workflow actions, wherein the user profile comprises a user credential for performing the workflow action on the document;
selecting the user credential; and
causing the workflow action to be performed on the document at the multifunction device using the user credential.

2. The method of claim 1, wherein the user credential comprises an encryption key, the workflow action comprising encrypting the document using the encryption key.

3. The method of claim 1, wherein the user credential comprises a decryption key, the workflow action comprising decrypting the document using the decryption key.

4. The method of claim 1, wherein the user credential comprises a signature generation key, the workflow action comprising:
generating a signature using the signature generation key, and
signing the document using the generated signature.

5. The method of claim 1, wherein the user credential comprises a signature verification key associated with a different user than the user associated with the profile, the document being received at the multifunction device from the different user, the workflow action comprising:
verifying a signature of the document using the signature verification key.

6. The method of claim 1, wherein the user credential comprises a public key associated with a different user than the user associated with the user profile, the workflow action comprising:
encrypting the document using the public key associated with the different user; and
sending the document o the different user using the multifunction device.

7. The method of claim 1, wherein accessing the user profile comprises accessing the user profile from storage of the multifunction device.

8. The method of claim 1, wherein accessing the user profile comprises accessing the user profile from a storage device external to the multifunction device.

9. A non-transitory, machine-readable storage medium encoded with instructions executable by a processor of a multifunction device, the machine-readable storage medium comprising:
instructions for accessing a user profile associated with a user for enabling workflows, wherein the user profile comprises a plurality of user credentials, each user credential enabling the multifunction device to cause a workflow action to be performed on a document,
instructions for selecting a user credential from the plurality of ser credentials, and
instructions for causing the workflow action to be performed on the document at the multifunction device using the user credential.

10. The machine-readable storage medium of claim 9, wherein the selected user credential comprises an encryption key, and wherein the workflow action comprises encrypting the document, the machine-readable storage medium further comprising:
instructions for encrypting the document using the encryption key.

11. The machine-readable storage medium of claim 9, wherein the selected user credential comprises a decryption key, and wherein the workflow action comprises decrypting the document, the machine-readable storage medium further comprising:
instructions for decrypting the document using the decryption key.

12. The machine-readable storage medium of claim 9, wherein the selected user credential comprises a signature generation key, and wherein the workflow action comprises digitally signing the document, the machine-readable storage medium further comprising:
instructions for generating the signature using the signature generation key.

13. The method of claim 9, machine-readable storage medium of claim 9, wherein the selected user credential comprises a signature verification key associated with a different user than the user associated with the profile, and wherein the workflow action comprises verifying a signature associated with the document received at the multifunction device from the different user, the machine-readable storage medium further comprising:
instructions for verifying the signature associated with the document using the signature verification key.

14. The method of claim 9, machine-readable storage medium of claim 9, wherein the selected user credential comprises a public key associated with a different user than the user associated with the profile, and wherein the workflow action comprises encrypting the document, the machine-readable storage medium further comprising:
instructions for encrypting the document using the public key associated with the different user.

15. A multifunction device comprising a processor to:
receive input from a user to manage a user profile, wherein the input comprises a user profile management action, the user profile management action comprising one of: generating a new key, updating a key, discarding a key, and creating a new user profile;
verify that the user is authorized to manage the user profile; and
performing the user profile action on a user profile at the multifunction device.
